(19) United States
(12) Patent Application Publication
(10) Pub. No.: US 2016/0354909 A1
(43) Pub. Date: Dec. 8, 2016

(54) MULTI-PURPOSE HANDHELD TOOL APPARATUS

(71) Applicant: MIW Associates, LLC, Havertown, PA (US)

(72) Inventors: Marvin WEINBERGER, Havertown, PA (US); Justin DODD, Philadelphia, PA (US)

(73) Assignee: MIW Associates, LLC, Havertown, PA (US)

(21) Appl. No.: 15/172,907

(22) Filed: Jun. 3, 2016

Related U.S. Application Data
(60) Provisional application No. 62/170,206, filed on Jun. 3, 2015.

(51) Int. Cl. B25F 1/04; B25F 1/00; B25B 15/00; A62B 3/00; B26B 23/00; B26B 11/00; B23D 49/10; B25D 1/04; B25B 13/48

(52) U.S. Cl. CPC B25F 1/04; B25D 1/04; B25F 1/006; B25B 15/008; B25B 13/48; B26B 23/00; B26B 11/00; B23D 49/10; A62B 3/005

(57) ABSTRACT

A multi-purpose handheld tool apparatus for emergency and rescue personnel. The apparatus, incorporates a handle operatively coupled to a hatchet head portion and a saw blade hingeably coupled to an end of the handle opposite the hatchet head portion. The saw blade is able to move between a recessed inoperative position at least partially received with the slot or cavity of the handle to an operative deployed position. The inventors have determined that apparatus provided herein is able to receive commercial saw blades designed for a variety of reciprocating saws. Additionally, by way of example, the inventors have determined that apparatus provided herein can permit the user to be effective in a variety of emergency and rescue operations with both ease and efficiency utilizing multiple tool application embodiments.

### CROSS-REFERENCE TO RELATED APPLICATION

This application claims priority to U.S. Provisional Patent Application Ser. No. 62/170,206 filed Jun. 3, 2015, the entirety of which is incorporated herein by reference.

### FIELD

The present disclosure generally relates to the technical field of multi-purpose tools. More specifically, the present disclosure is directed to a rugged heavy-duty multi-purpose tool apparatus.

### DESCRIPTION OF THE RELATED ART

Traditional multi-purpose handheld tools are limited in design and utility for the various operations and unique challenges that rescue workers and emergency response personnel may encounter. In addition, current multi-purpose tools are of limited effectiveness to the challenges presented in an emergency environment. Rescue workers are constantly searching for simple, inexpensive, multiple application devices that require less space that are highly mobile for use in a variety of emergency situations.

Many handheld tools are designed absent a coordinated purpose aimed at addressing a variety of emergency applications. Specifically, handheld tools may either be too compact to be utilized for complex rugged applications or too bulky to be appropriate for rescue personnel. In contrast, many individual tools provide a robust durable device for complex emergency situations but have limited utility for multiple applications. Thus, these tools require personnel to carry multiple different tools to be limiting the effectiveness and efficiency for rescue operations.

Multi-purpose handheld prior art tools do not meet the current needs of rescue workers. In addition, these tools are of limited utility to non-rescue workers, whether due to their cost, size, and/or specialized feature set.

### SUMMARY

In some embodiments of the present disclosure, a multi-purpose handheld tool is provided including a handle, a hatchet head portion operatively coupled to the handle, and a saw blade hingeably coupled to the handle. The saw blade can be moved from a position in which it is at least partially received within a slot located in the handle formed from a plurality of at least two handle portions.

In various embodiments of the present disclosure, a multi-purpose device is provided including an elongated handle having two ends a cavity, a blade carrier hingeably coupled to the handle first end, a saw blade removeably coupled to a blade carrier, and a latch operatively coupled to the handle. When the latch is in a first position, the saw blade is at least partially recessed within the cavity of the handle in an inoperative position. When the latch is operated toward a second position, the saw blade rotates outwardly from the cavity of the handle to an operative position. A hatchet head portion is operatively coupled to the second end of the handle.

In some embodiments of the present disclosure, a multi-purpose tool is provided including a handle having a proximal and distal end wherein a tool head is disposed at the proximal end of the handle and a saw blade is operatively coupled to the distal end of the handle. The tool head further comprising a hatchet blade and a hammer head on opposite sides.

The foregoing and additional aspects and embodiments of the present invention will be apparent to those of ordinary skill in the art in view of the detailed description of various embodiments and/or aspects, which is made with reference to the drawings, a brief description of which is provided next.

### BRIEF DESCRIPTION OF THE DRAWINGS

Various aspects of the present disclosure will be or become apparent to one with skill in the art by reference to the following detailed description when considered in connection with the accompanying exemplary non-limiting embodiments.

FIG. 1A is a front side view of a multi-purpose handheld tool with a saw blade in a recessed position in accordance with some embodiments of the present disclosure.

FIG. 1B is a back side view of the multi-purpose handheld tool of FIG. 1A with the saw blade in the recessed position in accordance with some embodiments of the present disclosure.

FIG. 1C is a perspective view of the multi-purpose handheld tool of FIG. 1A with the saw blade in the recessed position in accordance with some embodiments of the present disclosure.

FIG. 2A is a top view of the multi-purpose handheld tool of FIG. 1A in accordance with some embodiments of the present disclosure.

FIG. 2B is a bottom view of the multi-purpose handheld tool of FIG. 1A with the saw blade in a recessed position in accordance with some embodiments of the present disclosure.

FIG. 3A is a front side profile view of the multi-purpose handheld tool of FIG. 1A with the saw blade in the recessed position in accordance with some embodiments of the present disclosure.

FIG. 3B is a back side profile view of the multi-purpose handheld tool of FIG. 1A with the saw blade in the recessed position in accordance with some embodiments of the present disclosure.

FIG. 4A is partial front side view of a multi-purpose handheld tool handle and blade carrier with the saw blade in a recessed position in accordance with some embodiments of the present disclosure.

FIG. 4B is a partial front side view of the multi-purpose handheld tool handle and blade carrier of FIG. 4A with the saw blade in a partially deployed position in accordance with some embodiments of the present disclosure.

FIG. 4C is a partial front side view of the multi-purpose handheld tool handle and blade carrier of FIG. 4A with the saw blade in a deployed position in accordance with some embodiments of the present disclosure.

FIG. 5 is a partial exploded component view of a multi-purpose handheld tool handle in accordance with some embodiments of the present disclosure.

FIG. 6A is a front side view of a multi-purpose handheld tool with a saw blade in a slotted position in accordance with some embodiments of the present disclosure.

FIG. 6B is a front side view of the multi-purpose handheld tool of FIG. 6A with the saw blade in deployed position in accordance with some embodiments of the present disclosure.

FIG. 7A is a partial front side view of a multi-purpose handheld tool handle and blade carrier with the saw blade in a slotted position in accordance with some embodiments of the present disclosure.

FIG. 7B is a partial front side view of the multi-purpose handheld tool handle of FIG. 7A with the saw blade in a deployed position in accordance with some embodiments of the present disclosure.

FIG. 8 is a partial exploded component view of a multi-purpose handheld tool with a slotted handle in accordance with some embodiments of the present disclosure.

### DETAILED DESCRIPTION

With reference to the figures, where like elements have been given like numerical designations to facilitate an understanding of the drawings, various embodiments of an apparatus for a multi-purpose handheld tool are described. The figures are not drawn to scale.

The following description is provided as an enabling teaching of a representative set of examples. Many changes can be made to the embodiments described herein while still obtaining beneficial results. Some of the desired benefits discussed below can be obtained by selecting some of the features discussed herein without utilizing other features. Accordingly, many modifications and adaptations, as well as subsets of the features described herein are possible and can even be desirable in certain circumstances. Thus, the following description is provided as illustrative and is not limiting.

This description of illustrative embodiments is intended to be read in connection with the accompanying drawings, which are to be considered part of the entire written description. The drawing figures are not necessarily to scale and certain features of the invention can be shown exaggerated in scale or in somewhat schematic form in the interest of clarity and conciseness. In the description of embodiments disclosed herein, any reference to direction or orientation is merely intended for convenience of description and is not intended in any way to limit the scope of the present disclosure. Relative terms such as “horizontal,” “vertical,” “up,” “down,” “top,” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “inwardly” versus “outwardly,” “longitudinal” versus “lateral,” and the like are to be interpreted relative to one another or relative to an axis of elongation, or an axis or center of rotation, as appropriate. Terms concerning attachments, coupling, and the like, such as “connected” “interconnected,” “attached,” and “affixed,” refer to a relationship wherein structures are secured or attached to one another either directly or indirectly through intervening structures, as well as both movable or rigid attachments or relationships, unless expressly described otherwise. The terms “operatively connected” or operatively coupled” are such an attachment, coupling or connection that allows the pertinent structures to operate as intended by virtue of that relationship. The term “adjacent” as used herein to describe the relationship between structures/components includes both direct contact between the respective structures/components referenced and the presence of other intervening structures/components between respective structures/components.

As used herein, use of a singular article such as “a,” “an” and “the” is not intended to exclude pluralities of the article's object unless the context clearly and unambiguously dictates otherwise.

The inventors have developed an apparatus for use as a rescue multi-purpose tool with retractable saw blade, both by rescue and non-rescue personnel. The multi-purpose tool permits the user to perform a variety of tasks without the need to rely on several different tools. For example, the inventors have determined that the apparatus provided herein is able to be used as device for rescue workers or emergency response personnel that require various utility applications in their duties, by survivalists, campers or others.

Additionally, by way of example, the inventors have determined that the apparatus provided herein can permit the user to safely cut, hammer, remove nails, saw, and perform additional other tasks that typically require multiple tools. In addition, the apparatus provided herein can permit ease of use and improved functionality in an emergency environment.

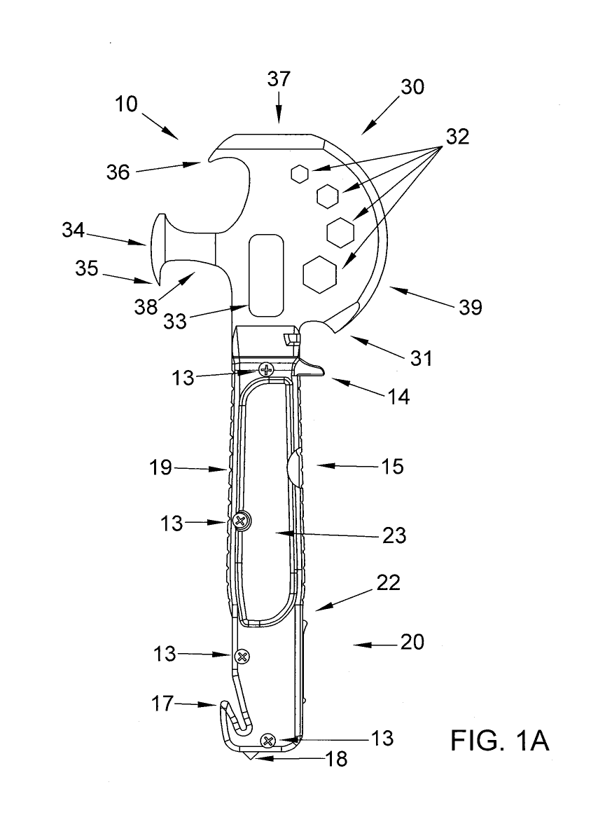

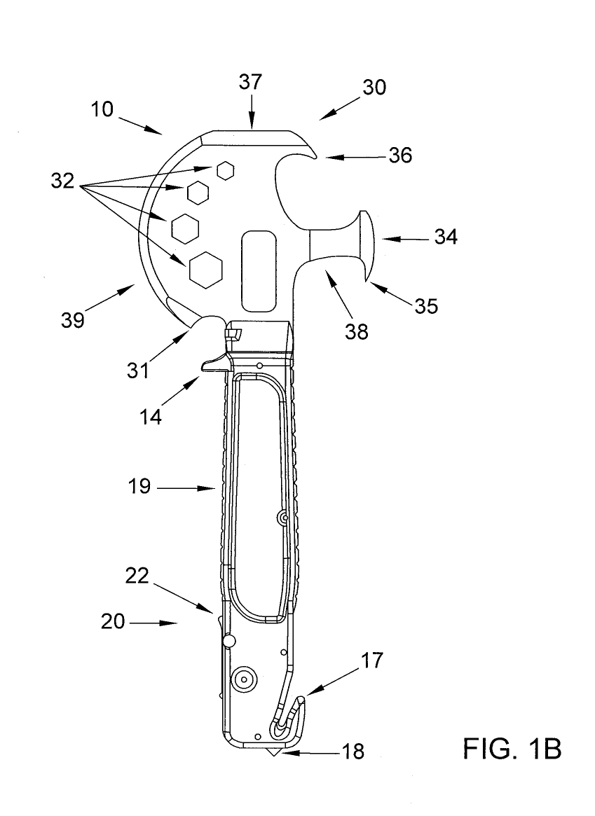

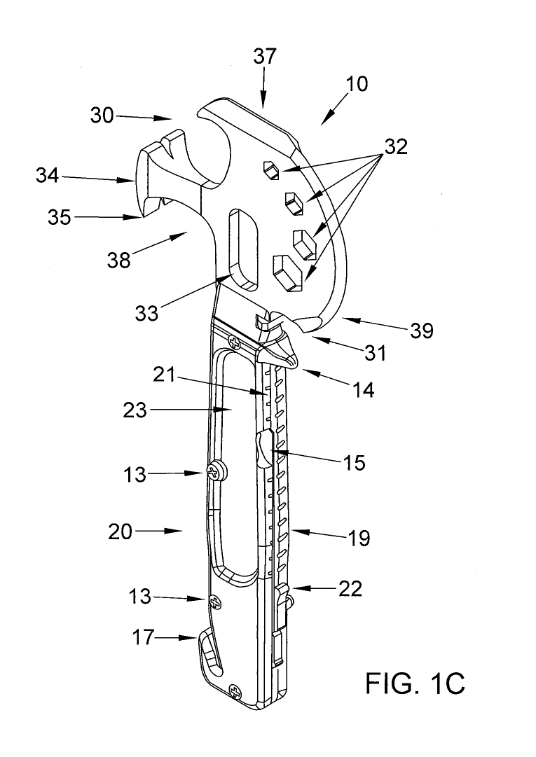

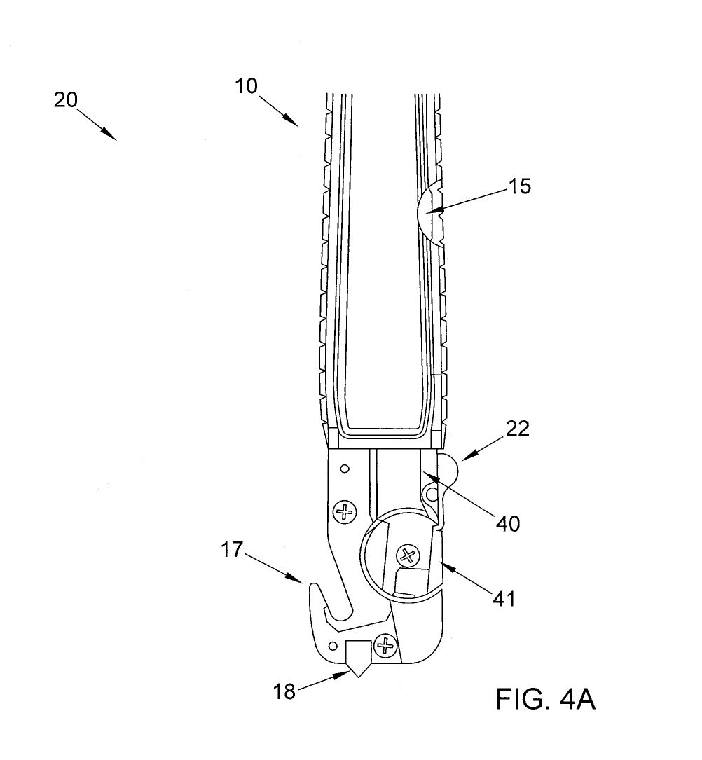

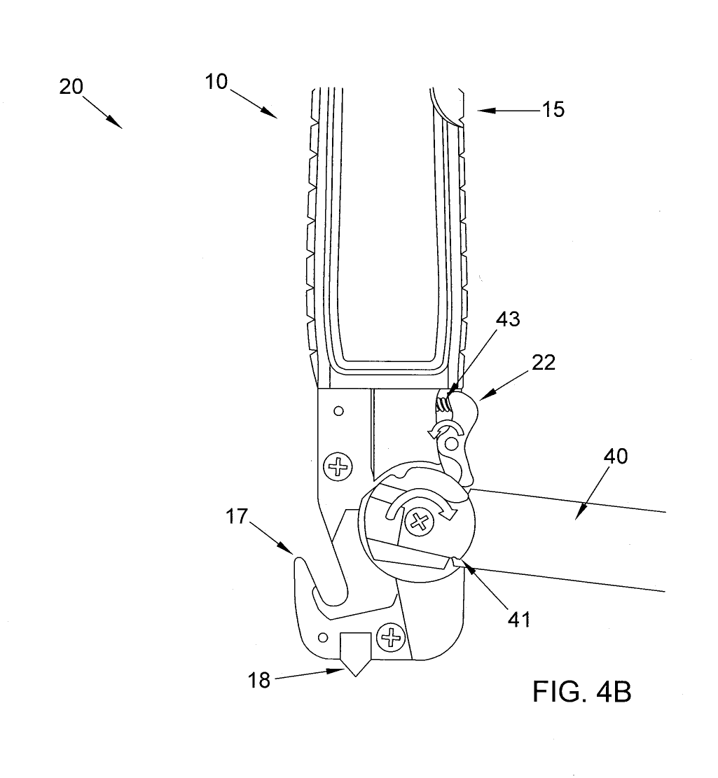

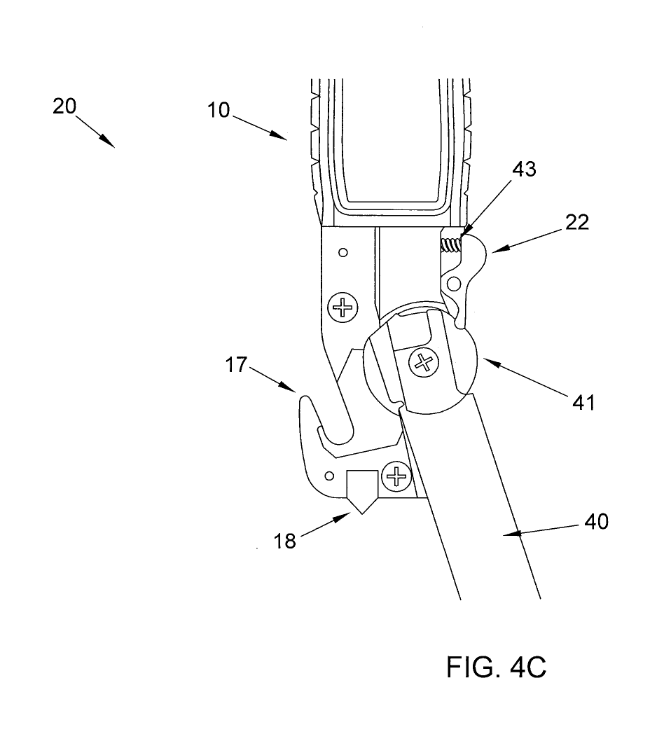

According to various embodiments in the figures, and particular to FIGS. 1A-1C, one example of a multi-purpose handheld tool 10 is illustrated. As shown in FIG. 1, multi-purpose handheld tool 10 comprises a handle 20 operatively coupled to a hatchet head portion 30 at a first end of handle 20 and a saw blade 40 (FIGS. 4A-4C) hingeably coupled at a second end of handle 20 opposing hatchet head portion 30. In some embodiments, handle 20 and hatchet head portion 30 comprise two or more portions that are assembled or joined together using adhesive, screws, integral snap fit mechanisms, and/or other methods for coupling. For example, multi-purpose handheld tool 10 can be configured to provide a means of conveniently replacing or removing the hatchet head portion 30. In the illustrated example depicted in the figures, handle 20 and hatchet head portion 30 are joined together with a snap fit mechanism (FIGS. 1A-1C). One of ordinary skill in the art, however, will understand that multi-purpose handheld tool 10 can also be formed as a unitary or monolithic structure.

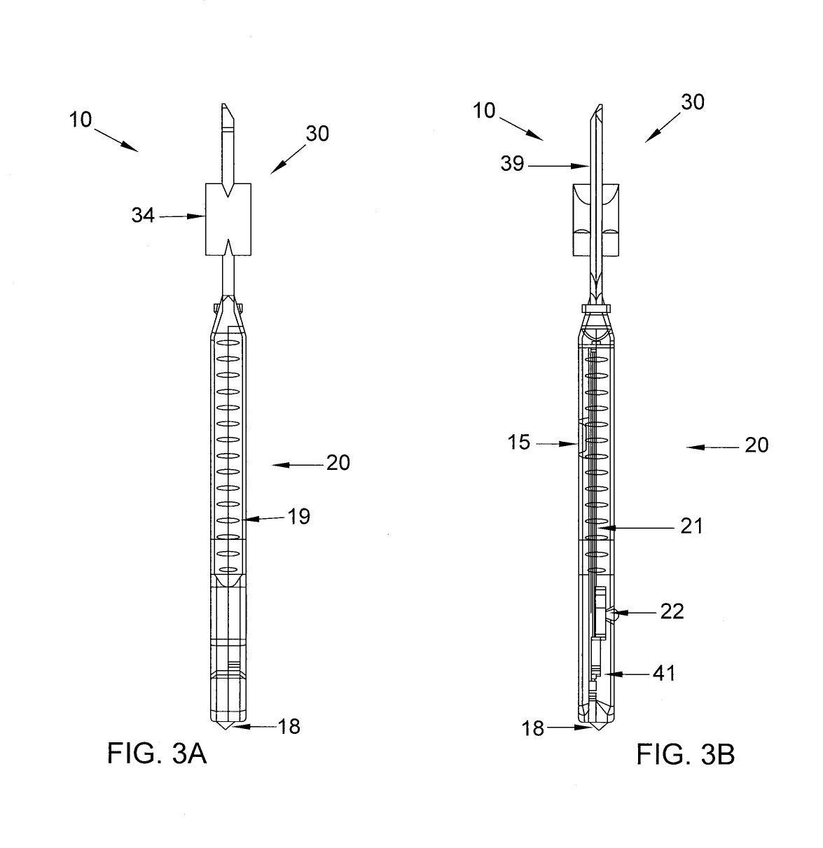

As shown in FIG. 1A-1C, handle 20 comprises two or more portions that are assembled or joined together using adhesive, screws, integral snap fit mechanisms, and/or other methods for coupling the two or more portions together. In the illustrated example depicted in the figures, the two individually molded portions are joined together with a plurality of bolts/screws 13. In various embodiments, the two or more portions of handle 12 are configured to define an interior slot or cavity 21 (FIGS. 1C and 3B for example). In some embodiments, handle 20 is elongated and configured to enhance the grip of the user. One of ordinary skill in the art, however, will understand that handle 20 can also be formed from various sizes, shapes, and lengths for the purpose of operating hatchet head portion 30 or saw blade 40 (FIGS. 4A-4C) in a utility like manner In various embodiments, handle 20 has a handgrip 19. In some embodiments, a plurality of grooves included on a portion of handle 20 form handgrip 19. In various embodiments, the sides of handle 20 may be depressed and configured to aid in gripping. In some embodiments, the sides of handle 20 may have raised or inset lettering.

According to some embodiments, handle 20 may be made of metal, high strength plastic, or any suitably rigid and strong material. In some embodiments, handle 20 may be made of metal harder than aluminum with corrosion resistant properties.

As shown in FIG. 1A-1C, handle 20 has a recessed cutting blade 17 operatively coupled to the second end of handle 20, according to various embodiments. In the illustrated example depicted in the figures, recessed cutting blade 17 is operatively coupled to handle 20 and configured to cut a belt/strap inserted into the illustrated recess. Recessed cutting blade 17 may be formed from two or more portions of handle 20. In various embodiments, recessed cutting blade 17 may be formed by inserting a means for cutting a belt/strap by disposing a blade into a unitary or monolithic handle 20. In some embodiments, recessed cutting blade 17 is configured to be replaceable within handle 20. In various embodiments, recessed cutting blade 17 may be a snap-off blade comprising different segments, for example, BR-033751D by American Cutting Edge of Centerville, Ohio. In some embodiments, replacement blade segments of the recessed cutting blade 17 may be stored in the handle of the tool. In some embodiments, handle 20 has a tip protrusion 18 operatively coupled to the second end of handle 20 for breaking glass. In some embodiments, tip protrusion 18 and recessed cutting blade 17 are assembled or joined to handle 20 using adhesive, screws, or disposed between the one or more portions of handle 20. Tip protrusion 18 is configured to impart shattering force on glass when striking with handle 20. In some embodiments, tip protrusion 18 is comprised of carbide. In various embodiments, tip protrusion 18 may comprise any material of sufficient strength configured to break glass. In various embodiments, tip protrusion 18 is configured to be replaceable within handle 20.

As best seen in FIGS. 1A and 1C, handle 20 has a depression 23 on at least one exterior side face of a joined together portion, according to various embodiments. Depression 23 may be configured to permit a graphical or text engraving for product identification. In the illustrated example depicted in FIGS. 1A and 1C, an inlay can be inserted in depression 23 to show brand specific information.

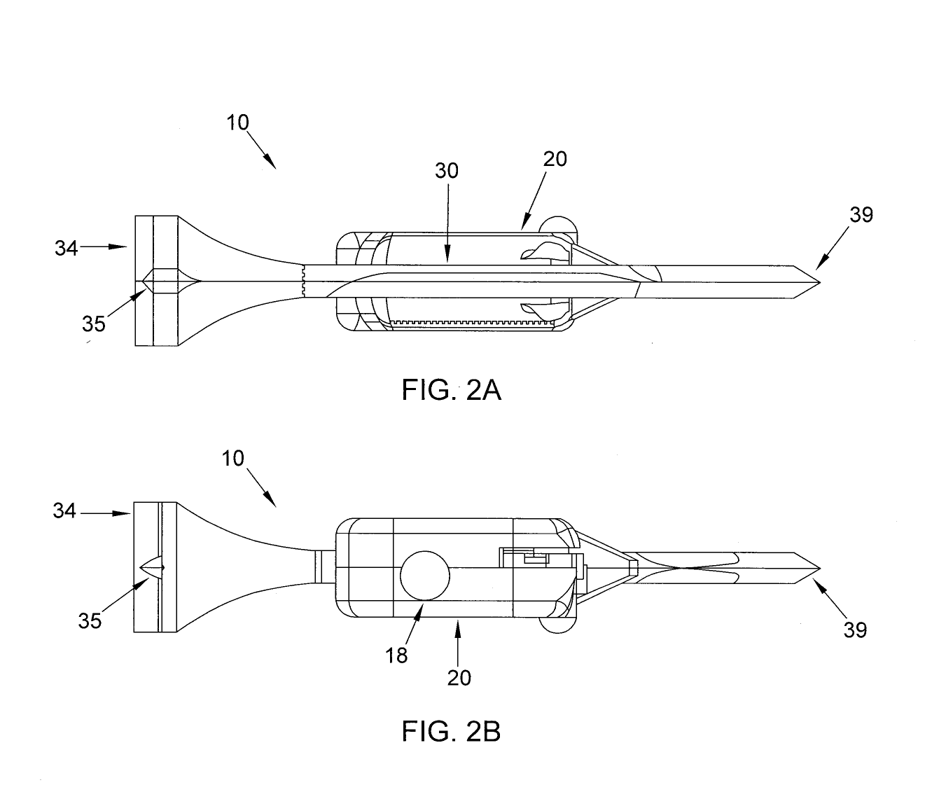

FIG. 2A is a top view of the multi-purpose handheld tool 10 in accordance with some embodiments of the present disclosure. FIG. 2B is a bottom view of the multi-purpose handheld tool 10 in accordance with some embodiments of the present disclosure. As illustrated in FIGS. 1A-1C and 3A-3B, hatchet head portion 30 is operatively coupled to the handle 20. In some embodiments, hatchet head portion 30 has two diametrically opposed sides or faces. In various embodiments, hatchet head portion 30 may be made of metal, or any substantially rigid strong material. In some embodiments, hatchet head portion 30 may be made of a metal with corrosion resistant properties. Handle 20 and hatchet head portion 30 can also be formed as a unitary or monolithic structure from a single piece of material. One of ordinary skill in the art, however, will understand that handle 20 and hatchet head portion 30 may be joined by fusing, welding, or other suitable means of connecting two individual pieces.

According to various embodiments, a hatchet head portion 30 has a hatchet blade 39. Hatchet blade 39 is configured to form a blade edge from the converging end of the diametrically opposed sides or faces. In various embodiments, the blade edge of hatchet blade 39 is formed by converging tapered portions of the diametrically opposed sides or faces. In some embodiments, the hatchet blade is disposed on the same side as that of the blade edge of a deployed saw blade 40 (FIGS. 4A-4C). In some embodiments, hatchet blade 39 is substantially curvilinear or rounded in shape. In various embodiments, the blade edge of hatchet blade 39 is configured to have an outer circumferential edge of approximately one hundred eighty degrees (e.g. between one hundred-forty and two hundred-twenty degrees). Hatchet blade 39 may have a secondary blade edge 31 formed substantially in line with the blade edge of hatchet blade 39 and configured to aid in extracting multi-purpose handheld tool 10 when hatchet blade 39 is engaged with a cutting material. Multi-purpose hand held tool 10 may be rolled or pivoted on the circumferential edge of hatchet blade 39 onto secondary blade edge 31 to remove hatchet blade 39 from an engaged cutting material. A can opener may be formed from the secondary blade edge 31 and a protrusion 14 extending from and operatively coupled to handle 20.

FIG. 3A is a front side profile view of a multi-purpose handheld tool in accordance with some embodiments of the present disclosure. FIG. 3B is a front side profile view of a multi-purpose handheld tool in accordance with some embodiments of the present disclosure. Hatchet head portion 30 has a hammer head 34 according to various embodiments. Hammer head 34 is operatively coupled to hatchet head portion 30 with an elongated neck that extends outward from the side opposite hatchet blade 39, according to various embodiments. In some embodiments, hammer head 34 may have a substantially curved outer face. In various embodiments, hammer head 34 has a substantially flat outer face configured to impart force on a nail or object. In some embodiments, hammer head 34 has a nail puller 35. The elongated neck coupling hammer head 34 and hatchet head portion 30 is of sufficient length to provide a spanner wrench socket 38 disposed between nail puller 35 and hatched head portion 30. In some embodiments, hammer head 34 has an overhang configured to catch a hose coupling to serve as a spanner wrench socket 38.

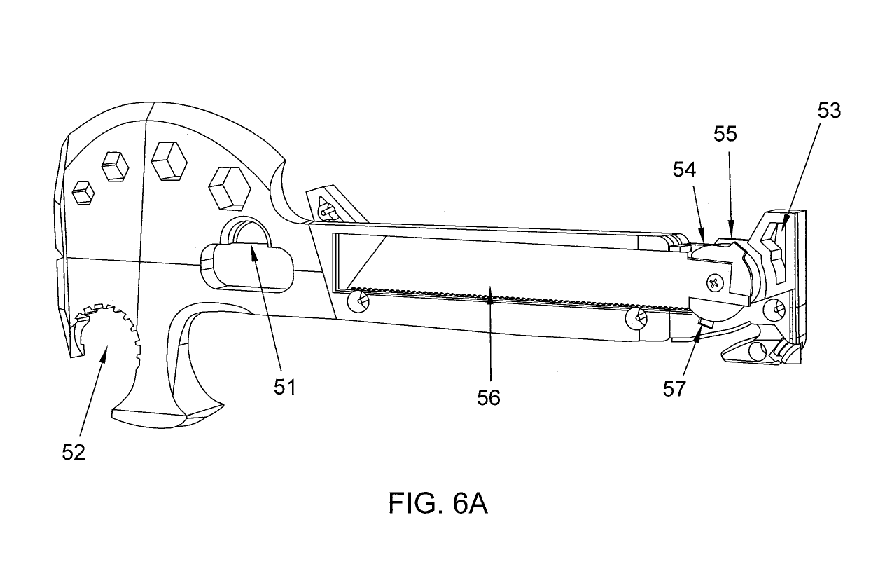

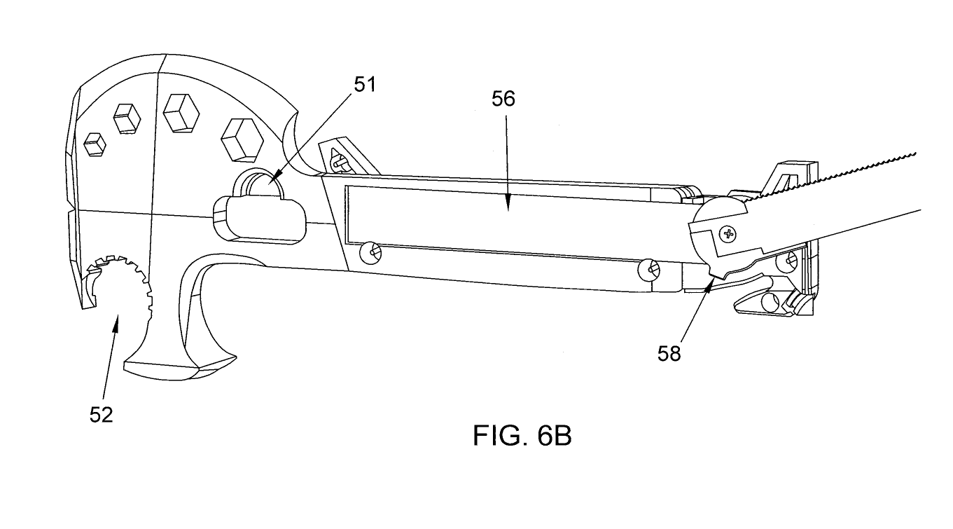

According to various embodiments, hatchet head portion 30 has a plurality of openings to accommodate various utility applications. As illustrated for example in FIG. 1A-1C, hatchet head portion 30 has a plurality of hexwrench openings 32. In some embodiments, the plurality of hexwrench openings 32 are varying different sizes. In various embodiments, hexwrench openings 32 are configured to maintain engagement and impart torsion force with hexagonal face screws. In some embodiments, a gas valve wrench opening 33 is operatively disposed in hatchet head portion 30 and configured to maintain engagement and operate a gas valve. In various embodiments, gas valve wrench opening 33 has a hemispherical opening 51 (FIGS. 6A and 6B) to accommodate different types of gas valves. In various embodiments, hatchet head portion 30 comprises an opening or indentation configured to be a bottle opener.

In some embodiments, a hook 36 is operatively coupled to hatchet head portion 30 and extends into a space between hammer head 34 and hatchet head portion 30. Hook 36 is configured to provide a capture device for securing or maintaining engagement of multipurpose handheld tool 10. In some embodiments, a wedge or pry 37 is formed at the top of hatched head portion 30 opposite the end of the operatively coupled handle 20. In some embodiments, a can opener may be formed from hook 36 and hammer head 34 (FIGS. 6A and 6B). In various embodiments, a hemispherical space 52 (FIGS. 6A and 6B) is formed between hook 36 and hammer head 34 to provide a means for gripping or hooking objects. In some embodiments, hemispherical space 52 (FIGS. 6A and 6B) has a plurality of teeth or gears to assist in gripping or hooking objects.

FIG. 4A is a front side view of a multi-purpose handheld tool handle and blade carrier with the saw blade in a recessed position in accordance with some embodiments. According to various embodiments in the figures, and in particular FIGS. 4A-4C, one example of handle 20 is illustrated. In some embodiments, handle 20 is pivotably coupled with respect to a saw blade 40. In some embodiments, handle 20 is operably coupled to saw blade 40. Saw blade 40 may be any saw blade suitable to fit in a reciprocating saw that has an interchangeable saw blade feature. In various embodiments, saw blade 40 may be the following reciprocating saw blade: Milwaukee 48-00-5182 Super SAWZALL® Blade 14 Teeth per Inch 6-Inch Length available from Milwaukee Electric Tool of Brookfield, Wis. In some embodiments, saw blade 40 may be removed or interchangeable with a replacement saw blade. In various embodiments, saw blade 40 is pivotably coupled and configured to be permanently attached to handle 20. One of ordinary skill in the art will understand, that a saw blade made be formed with a plurality of teeth and vary in length and constructed material. According to various embodiments, saw blade 40 is configured to be at least be partially received within slot or cavity 21 in handle 20 (FIGS. 1C and 3B for example).

FIG. 4B is a front side view of a multi-purpose handheld tool handle and blade carrier with the saw blade 40 in a partially deployed position in accordance with some embodiments. In various embodiments, saw blade 40 is pivotably coupled to handle 12. In some embodiments, a blade carrier 41 is operatively coupled to handle 12 and configured to provide a fastening or connecting means for saw blade 40. Blade carrier 41 is configured to rotate a coupled saw blade 40 from at least a partially recessed position within slot or cavity 21 to a deployed position external to slot or cavity 21. In some embodiments, saw blade 40 is removeably coupled to blade carrier 41. According to various embodiments, saw blade 40 is configured to be deployed at an angle approximately one hundred eighty degrees (e.g. between one hundred-forty and two hundred-twenty degrees).

FIG. 4C is a front side view of a multi-purpose handheld tool handle and blade carrier with the saw blade 40 in a deployed position in accordance with some embodiments. Saw blade 40 is removeably coupled to blade carrier 41 and may be deployed by rotating blade carrier 41. In some embodiments, at least one portion of handle 20 has a depression 15 (FIG. 4A) configured to manually deploy saw blade 40 by permitting a user to grip or pull saw blade 40 from at least a partially recessed position within slot or cavity 21. In some embodiments, blade carrier 41 is operatively coupled to a spring 43 to aid in manually deploying saw blade 40 from slot or cavity 21.

In various embodiments, a latch 22 is operatively coupled to handle 20 and blade carrier 41. Latch 22 is operatively coupled such that, when latch 22 is in a first position, saw blade 40 is maintained in an inoperative position at least partially recessed within slot or cavity 21. In various embodiments, latch 22 is configured to engage a first notch on blade carrier 41 which maintains saw blade 40 in an inoperative position when latch 22 is in a first position. In some embodiments, when latch 22 is operated toward a second position, saw blade 40 is permitted to be deployed outward to an operative position from slot or cavity 21 by rotating blade carrier 41. In some embodiments, a spring 43 is operatively coupled to latch 22 to aid in deploying saw blade 40 outward when latch 22 is operated toward a second position. In various embodiments, latch 22 is configured to engage a second notch on blade carrier 41 which maintains saw blade 40 in a deployed position when blade carrier 41 has rotated approximately one hundred eighty degrees (e.g. between one hundred-forty and two hundred-twenty degrees).

According to some embodiments in the figures, and in particular to FIGS. 4A-4C, one example of multi-purpose handheld tool 10 is illustrated. As depicted in FIG. 4A, saw blade 40 is maintained in an inoperative position when latch 22 is in a first position and spring 43 (not depicted in FIG. 4A) is uncompressed. As further illustrated in FIG. 4A, latch 22 is configured to engage a first notch of blade carrier 41 which maintains saw blade 40 in an inoperative position, according to various embodiments. According to some embodiments, illustrated for example in FIG. 4B, latch 22 operatively coupled to blade carrier 41 is operated toward a second position (arrow depicted in FIG. 4B) which compresses spring 43. Compression of spring 43 toward handle 20 (see FIG. 4B) allows blade carrier 41 to rotate (arrow depicted in FIG. 4B), deploying saw blade 40 outward toward an operative position from slot or cavity 21, according to various embodiments. As illustrated in FIG. 4C, according to some embodiments, blade carrier 41 rotates until saw blade 40 is engaged in a locked or deployed position with handle 20. Blade carrier 41 is configured to engage latch 22 in a locked position when saw blade 40 is fully deployed. When latch 22 engages blade carrier 41 in a locked or deployed position, spring 43 is uncompressed which assist in arresting rotation of blade carrier 41 and locking saw blade 40 in a fully deployed position, according to various embodiments. According to some embodiments, illustrated for example in FIG. 4C, latch 22 is configured to engage a second notch of blade carrier 41 which maintains saw blade 40 in a locked or deployed position. According to this embodiment, when blade carrier 41 has rotated approximately one hundred eighty degrees (e.g. between one hundred-forty and two hundred-twenty degrees), latch 22 engages or mates with a second notch of blade carrier 41 permitting spring 43 to be uncompressed maintaining blade carrier 41 and saw blade 40 in a secured or fixed position. One of ordinary skill in the art will understand that latch 22 and spring 43 may be operatively coupled to blade carrier 41 using various methods sufficient to deploy saw blade 40. According to some embodiments, blade carrier 41 may be configured to have a plurality of notches that permit latch 22 to engage blade carrier 41 allowing saw blade 40 to deploy or stop at different angles relative to handle 20.

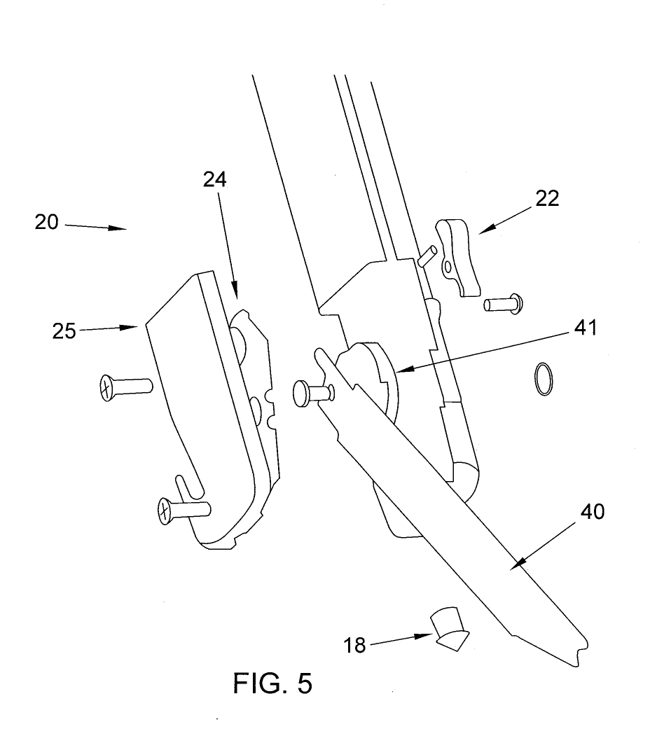

FIG. 5 is a component view of a multi-purpose handheld tool handle in accordance with some embodiments of the present invention. In various embodiments, handle 20 may comprise two or more portions joined or affixed together. In some embodiments, handle 20 may further comprise a replacement face 25 that is operatively coupled to handle 20 to provide access to saw blade 40 and blade carrier 41. In various embodiments, replacement face 25 is assembled or joined with handle 20 using bolts, screws, integral snap fit mechanisms, and/or other methods for coupling. Replacement face 25 may be operatively coupled with a utility blade 24 configured to be deployed from slot or cavity 21.

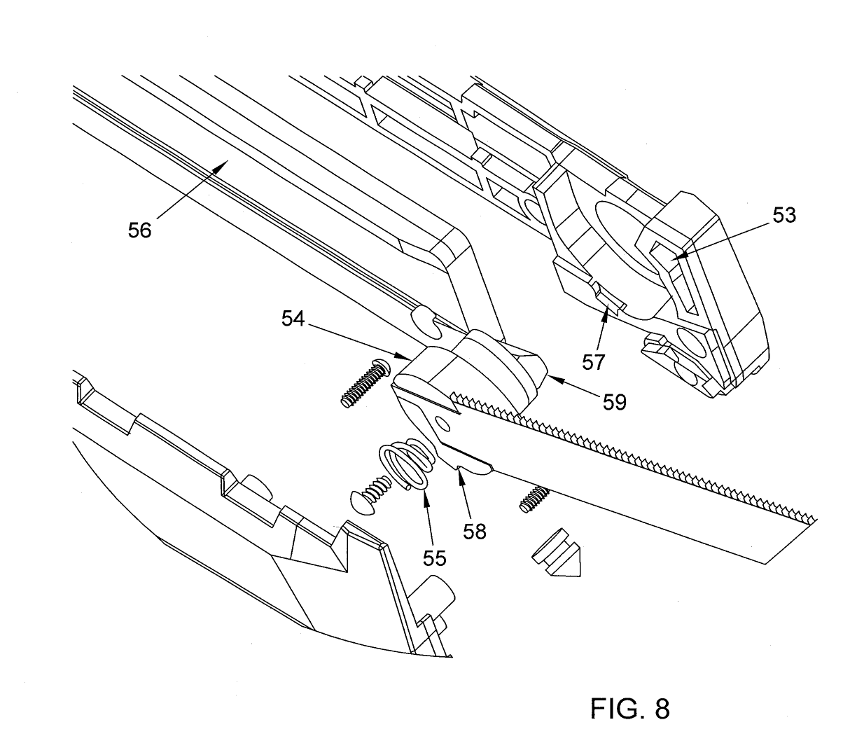

FIG. 6A is a front side view of a multi-purpose handheld tool with a saw blade in a slotted position in accordance with some embodiments. FIG. 6B is a front side view of the multi-purpose handheld tool of FIG. 6A with the saw blade in a deployed position in accordance with some embodiments. As illustrated in FIGS. 6A and 6B, handle 20 may comprise a slot or recess 56 along a planar side of handle 20 according to various embodiments. In some embodiments, slot or recess 56 of handle 20 is configured to at least partially recess saw blade 40 (FIGS. 4B and 4C) within handle 20. In some embodiments, slot or recess 56 of handle 20 is configured to provide access to saw blade 40 for quick removal without separating the one or more portions of handle 20. In various embodiments, slot or recess 56 is located within handle 20 and enclosed by the one or more portions of handle 20 (See FIG. 8). In some embodiments, handle 20 may have one or more portions that include a slot or recess portion 56 enclosed by one more or portions on either side of slot or recess portion 56.

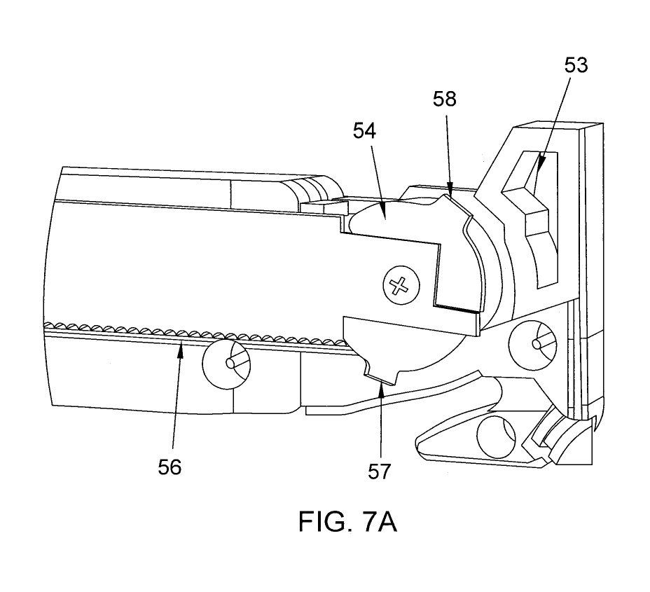

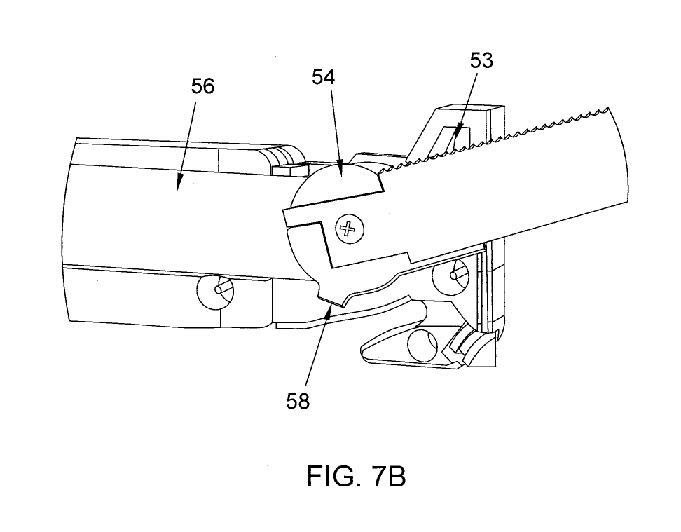

FIG. 7A is a partial front side view of a multi-purpose handheld tool handle and blade carrier with the saw blade in a slotted position in accordance with some embodiments. FIG. 7B is a partial front side view of the multi-purpose handheld tool handle of FIG. 7A with the saw blade in a deployed position in accordance with some embodiments. As illustrated in FIGS. 7A and 7B, blade carrier 54 is operatively coupled to handle 20 and an ejection spring 55 (FIG. 8) according to various embodiments. In some embodiments, blade carrier 54 may have a plurality of protrusions 58 that extend outward from the circular edge of blade carrier 54 and are configured to engage a slotted opening 57 in handle 20. In various embodiments, ejection spring 55 (FIG. 8) is configured to be compressed such that the saw blade 40 is ejected outward from slot or recess 56.

FIG. 8 is a partial exploded component view of a multi-purpose handheld tool with a slotted handle in accordance with some embodiments. According to various embodiments, when saw blade 40 is in a slotted position, ejection spring 55 is uncompressed and saw blade 40 is locked or affixed into slot or recess 55. As depicted in FIG. 8, blade carrier 54 operatively coupled to handle 20 and ejection spring 55 is configured to be pushed toward ejection spring 55 such that ejection spring 55 is compressed. According to various embodiments, when ejection spring 55 is compressed, blade carrier 54 operatively coupled to saw blade 40 is configured to rotate wherein saw blade 40 is configured to be ejected within handle 20 from slot or recess 56. According to some embodiments, blade carrier 54 and saw blade 40 are configured to rotate when ejection spring 55 is compressed such that saw blade 40 is rotated outward from cavity 21 of handle 20. When saw blade 40 is rotated into a deployed position, ejection spring 55 is configured to be uncompressed and protrusion 58 on the circular edge of blade carrier 54 engages slotted opening 57 in handle 20 such that saw blade 40 is locked or affixed in a deployed position. In some embodiments, blade carrier 54 is operatively coupled to a knob 59 which is configured to permit pushing or pressing blade carrier 54 toward ejection spring 55 allowing blade carrier 54 to rotate deploying saw blade 40 from handle 20. In various embodiments, blade carrier 54 may have a plurality of protrusions 58 configured to engage a plurality of slotted openings 57 in handle 20 such that saw blade 40 may be deployed and locked/affixed at various angles.

It may be emphasized that the above-described embodiments, are merely possible examples of implementations, and merely set forth a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure and the present disclosure and protected by the following claims.

While this specification contains many specifics, these should not be construed as limitations on the scope of any invention or of what may be claimed, but rather as descriptions of features that may be specific to particular embodiments of particular inventions. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

While various embodiments have been described, it is to be understood that the embodiments described are illustrative only and that the scope of the subject matter is to be accorded a full range of equivalents, many variations and modifications naturally occurring to those of skill in the art from a perusal hereof

What is claimed is:

1. A multi-purpose handheld tool, comprising:
a handle extending from a first end to a second end, the handle defining a slot between the first end and the second end;
a hatchet head portion operatively coupled to the first end of the handle; and
a saw blade hingeably coupled to the second end of the handle such the saw blade can be moved between an inoperative position in which the saw blade is at least partially received within the slot of the handle and an operative position where the saw blade extends from the handle.

2. The multi-purpose handheld tool of claim 1, further comprising a recessed cutting blade operatively coupled to the second end of the handle for cutting a belt or strap.

3. The multi-purpose handheld tool claim 1, further comprising a carbide tip protrusion operatively coupled to the second end of the handle for breaking glass.

4. The multi-purpose handheld tool of claim 1, wherein the saw blade is replaceable, the tool further comprising means for allowing replacement of the saw blade.

5. The multi-purpose handheld tool of claim 1, wherein the hatchet head portion comprises a hatchet blade disposed on a same side of the tool as the saw blade.

6. The multi-purpose handheld tool claim 1, further comprising a can opener operatively coupled to the first end of the handle portion, the can opener being formed from an end of the hatchet blade of the hatchet head portion and a protrusion extending from the handle and spaced from the end of the hatchet blade.

7. The multi-purpose handheld tool of claim 1, further comprising a plurality of hexwrench opening of different sizes disposed within the hatchet head portion.

8. The multi-purpose handheld tool of claim 1, further comprising a gas valve wrench opening within the hatchet head portion.

9. The multi-purpose handheld tool of claim 1, wherein the hatchet head portion comprises a hammer head disposed opposite of a hatch blade of the hatchet head portion.

10. The multi-purpose handheld tool of claim 9, wherein the hammer head further comprises a nail remover.

11. The multi-purpose handheld tool of claim 10, wherein the hammer head further comprises a means for twisting a wire.

12. The multi-purpose handheld tool of claim 10, wherein the hammer head is configured to form a spanner wrench socket with the hatchet head portion and the handle.

13. The multi-purpose handheld tool of claim 10, wherein the hammer head and hatchet head portion form a hook.

14. A multi-purpose device, comprising:
a handle having a first end and a second end and a cavity disposed between the first end and the second end;
a blade carrier hingeably coupled to the first end of the of the handle;
a saw blade removeably coupled to the blade carrier;
a latch operatively coupled to the handle and the blade carrier such that, when the latch is in a first position, the saw blade is maintained in an inoperative position at least partially recessed within the cavity of the handle and, when the latch is operated toward a second position, the saw blade is deployed outward from the cavity to an operative position; and
a hatchet head portion coupled to the second end of the handle.

15. The multi-purpose device of claim 14, further comprising a plurality of hexwrench opening of different sizes disposed within the hatchet head portion or a gas valve wrench opening.

16. The multi-purpose device of claim 14, further comprising a replacement face removeably coupled to the second end of the handle wherein the replacement face provides access to the saw blade and blade carrier for removing the saw blade from the blade carrier.

17. The multi-purpose device of claim 16, further comprising a utility blade operably coupled to the replacement face and configured to be deployed from the cavity.

18. The multi-purpose device of claim 16, further comprising a spring operatively coupled to the blade carrier to assist in deploying the saw blade outward from the cavity when the latch is operated toward a second position.

19. The multi-purpose device of claim 18, wherein the blade carrier is hingeably coupled to the first end of the handle, such that when the latch is operated toward a second position, the blade carrier rotates and the saw blade pivots outward from the cavity assisted by the spring.

20. A multi-purpose tool, comprising:
a handle having proximal and distal ends;
a tool head disposed at a proximal end of the handle, the tool head comprising a hatchet blade and a hammer head on opposite sides thereof; and
a replaceable saw blade operatively coupled to the distal end of the handle.
